(19) United States
(12) Patent Application Publication
(10) Pub. No.: US 2017/0211636 A1
(43) Pub. Date: Jul. 27, 2017

(54) COMPRESSOR

(71) Applicant: SANDEN HOLDINGS CORPORATION, Isesaki-shi, Gunma (JP)

(72) Inventor: Yuuji OIWAKE, Isesaki-shi, Gunma (JP)

(73) Assignee: SANDEN HOLDINGS CORPORATION, Isesaki-shi, Gunma (JP)

(21) Appl. No.: 15/328,379

(22) PCT Filed: Mar. 17, 2015
(86) PCT No.: PCT/JP2015/057794

§ 371 Date: Jan. 23, 2017

(30) Foreign Application Priority Data
Jul. 23, 2014 (JP) 2014-149625

(51) Int. Cl. F16D 27/14; B60H 1/32; B60R 16/03; F16D 27/04; B60R 16/02

(52) U.S. Cl. CPC F16D 27/14; F16D 27/04; B60R 16/0207; B60R 16/03; B60H 1/3222

(57) ABSTRACT

Provided is a compressor including an electromagnetic clutch configured to enable and disable the transmission of a driving force from a drive source, in which the durability of a wiring harness for supplying electric power to an electromagnetic clutch is satisfactorily maintained. In a compressor 1, a boss 3b of a front housing 3 is provided with a rib 12 which prevents a finger from entering between a wiring harness 9 and a wall surface of the front housing 3, the rib 12 being formed along the wiring route of the wiring harness 9 in a part between a connection opening 6b of a clutch housing 6a for the wiring harness 9 and a peripheral wall of the front housing 3 to which the wiring harness 9 is fixed.

### TECHNICAL FIELD

The present invention relates to a compressor which is used in a vehicle air conditioner or the like, and more particularly relates a compressor including a drive shaft which rotationally drives a compression mechanism and an electromagnetic clutch which is disposed on one end portion of the drive shaft to enable and disable the transmission of a driving force from a drive source to the drive shaft.

### BACKGROUND ART

In this type of compressor, a wiring harness which is electrically connected to an electromagnetic clutch and drawn out of a clutch housing is fixed to a peripheral wall portion of a compressor housing connected to the clutch housing by a fastening metal fitting or the like, as described in Patent Document 1.

### REFERENCE DOCUMENT LIST

### Patent Document

Patent Document 1: Japanese Patent Application Laid-open Publication No. 10-184382

### SUMMARY OF THE INVENTION

### Problems To Be Solved By The Invention

In the wiring harness mounting structure described above, in the case where, for example, the diameter of the front end portion of a compressor housing connected to a clutch housing is smaller than the diameter of the peripheral wall of the compressor housing to which the clutch housing and the wiring harness are fixed, a gap may be formed between the wiring harness and the outer wall of the front end portion of the compressor housing, and human fingers may enter or get caught in the gap.

The structure may inconveniently allow a worker of a manufacturer or the like to hold the wiring harness and then lift the compressor. This may apply a large force to the wiring harness, leading to a disconnection or the like with resultant deterioration of durability.

The present invention has been made with a view toward solving the foregoing problem associated with the conventional art, and an object of the invention is to provide a compressor that suppresses the deterioration of durability by minimizing the chance of the wiring harness being held even in a compressor that has the foregoing structure.

### Means For Solving The Problems

To this end, the present invention provides a compressor including a drive shaft which rotationally drives a compression mechanism and an electromagnetic clutch which is disposed on one end portion of the drive shaft to enable and disable the transmission of a driving force from a drive source to the drive shaft. In the compressor, a wiring harness which is electrically connected to the electromagnetic clutch and which is drawn out of a clutch housing is fixed to a predetermined portion of a peripheral wall of a compressor housing connected to the clutch housing, the predetermined portion of the peripheral wall being spaced away from the clutch housing, and the compressor housing is provided with a rib which prevents a finger from entering between the wiring harness and a wall surface of the compressor housing, the rib being formed along a wiring route of the wiring harness in a part between an outlet through which the wiring harness is drawn out from the clutch housing and the peripheral wall to which the wiring harness is fixed.

### Effects of the Invention

In the compressor according to the present invention, the rib formed along the wiring route of the wiring harness prevents fingers from entering between the wiring harness and the wall surface of the compressor housing. This arrangement prevents the compressor from being held by holding the wiring harness, so that the disconnection or the like of the wiring harness is suppressed, thus making it possible to satisfactorily maintain the durability of the wiring harness.

### BRIEF DESCRIPTION OF THE DRAWINGS

FIG. 1 is a side view of a compressor of a vehicle air conditioner according to a first embodiment of the present invention;

FIG. 2 is a side view of the compressor illustrated in FIG. 1, which is observed from a direction in which the compressor has been rotated by 90 degrees about an axis;

FIG. 3 is a longitudinal sectional view of a front end portion of the compressor;

FIG. 4 is a sectional view of an essential section of a rib for securing the durability of a wiring harness according to a second embodiment of the present invention; and

FIG. 5 is a sectional view of an essential section of a rib for securing the durability of a wiring harness according to a third embodiment of the present invention.

### MODE FOR CARRYING OUT THE INVENTION

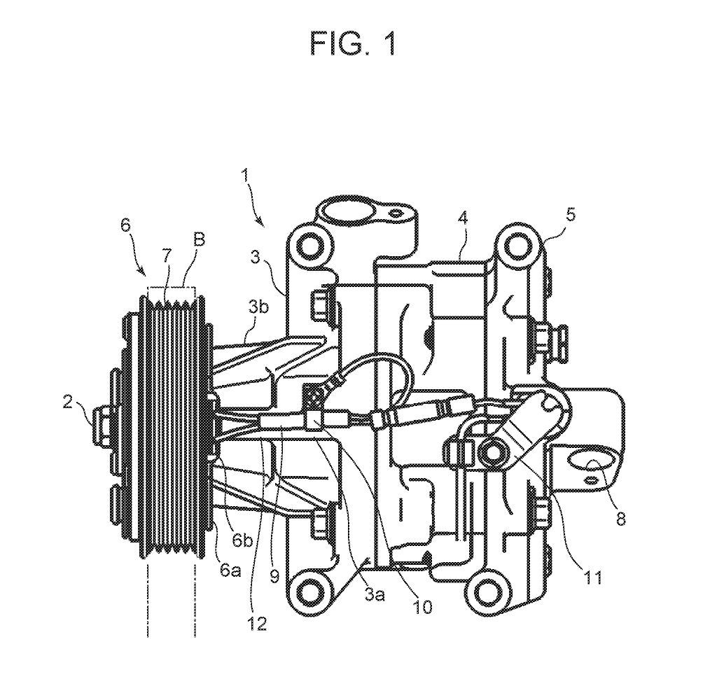

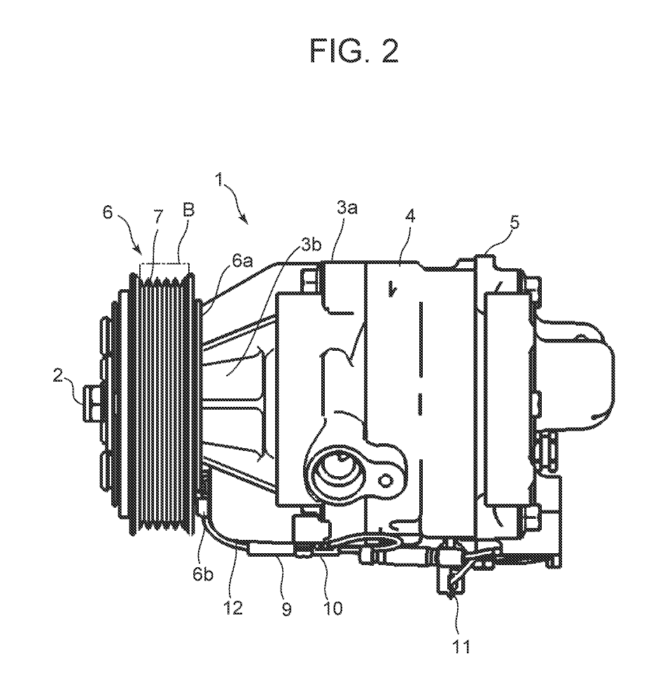

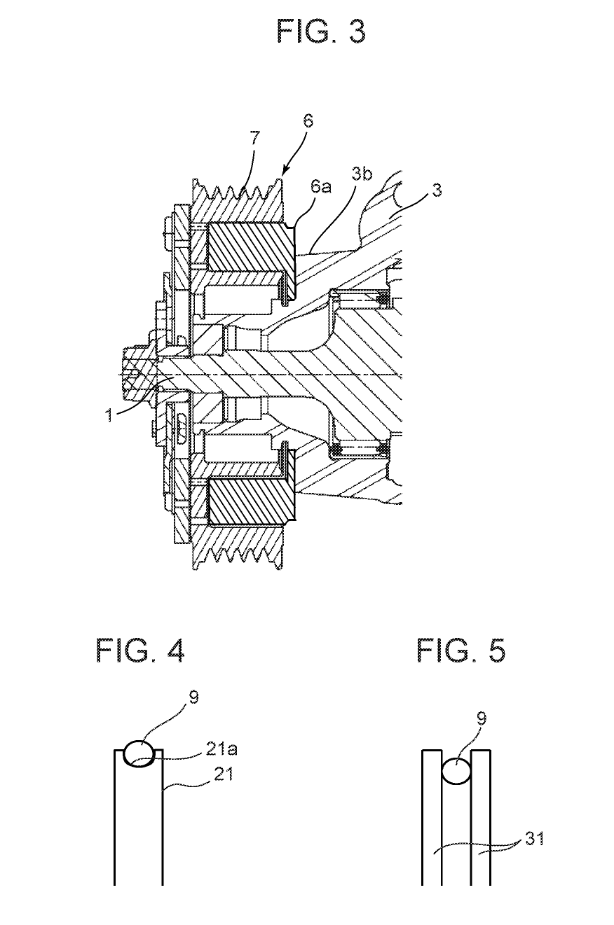

Embodiments of the present invention will be described below with reference to the accompanying drawings. FIG. 1 is a side view of a compressor of a vehicle air conditioner according to a first embodiment of the present invention, FIG. 2 is a side view of the compressor illustrated in FIG. 1, which is observed from a direction in which the compressor has been rotated by 90 degrees about the axis; and FIG. 3 is a longitudinal sectional view of a front end portion of the compressor.

In a compressor 1, a front housing 3, a center housing 4, and a rear housing 5 are fastened to each other by bolts (not illustrated) along the axial direction of a drive shaft 2. These front housing 3, the center housing 4, and the rear housing 5 constitute the compressor housing.

The front end portion of the drive shaft 2 projects toward the front of the front housing 3 and an electromagnetic clutch 6 is installed to the front end portion of the drive shaft 2.

A pulley 7 constitutes an input-side member of the electromagnetic clutch 6. A belt B is wound on the pulley 7 and on a pulley (not illustrated) which is mounted on a drive shaft of a drive source, such as an engine or a motor, or is mounted on a rotating shaft interlocked with the drive shaft. With this arrangement, when the electromagnetic clutch 6 is activated, the drive shaft 2 is rotationally driven by a rotational driving force supplied through the pulley 7. Further, when the electromagnetic clutch 6 is deactivated, the transmission of the rotational driving force of the drive source to the drive shaft 2 of the compressor 1 is cut off.

Provided in the center housing 4 is a pump mechanism having a volume chamber, the volume of which changes as the drive shaft 2 rotates. A refrigerant gas introduced into the volume chamber is compressed as the volume of the volume chamber changes, and the compressed refrigerant gas is discharged.

The refrigerant gas discharged from the pump mechanism is led out to the outside via a discharge chamber formed in the rear housing 5 and through a discharge port 8 and supplied to a heat exchanger (condenser), which is not illustrated.

In the electromagnetic clutch 6, a connection opening 6b to which the wiring harness for supplying electric power is connected is disposed in a clutch housing 6a, which houses an electromagnetic coil.

Further, the electromagnetic coil and a wiring harness 9 for supplying electric power are electrically connected at the connection opening 6b through a connector therein. The wiring harness 9 is connected to the connector, being oriented toward the outer side in the radial direction of the clutch housing 6a.

The wiring harness 9 having the front end portion thereof connected at the connection opening 6b is fixed to a peripheral wall 3a of the front housing 3 by a fastening metal fitting 10, and also fixed to a peripheral wall of the center housing 4 or the rear housing 5 by a fastening metal fitting 11 at the rear. The rear end portion of the wiring harness 9 is connected to an electric power supply source (not illustrated).

In the compressor 1 according to the present embodiment, in order to secure the durability of bearings that support the drive shaft 2 at the front and the rear in the front housing 3, a long distance is provided between the bearings, resulting in the long shape of a boss 3b at the front side of the front housing 3.

In this case, the boss 3b is formed to have a diameter that is smaller than the diameter of the peripheral wall 3a of the front housing 3 to which the clutch housing 6a and the wiring harness 9 are fixed, so that there is a large space between the rear surface of the clutch housing 6a and the peripheral wall 3a of the front housing 3.

Hence, if the foregoing space exists on the inner side of a wiring harness, then the wiring harness could be held by inserting fingers into the space. Lifting the compressor by holding the wiring harness would apply a heavy weight of the compressor to the wiring harness, thus impairing the durability, typically exemplified by the wiring harness becoming prone to disconnection.

In order to avoid the foregoing problem, therefore, the following configuration is adopted.

In the present embodiment, the boss 3b of the front housing 3 is provided with a rib 12 which is close to (including contact with) the wiring harness 9 and which extends along the wiring route to a portion of the front housing 3 in which the wiring harness 9 drawn outward in the radial direction from the connection opening 6b is fastened by the fastening metal fitting 10.

The rib 12 is formed such that the width of the top face thereof adjacent to the wiring harness 9 is equal to or greater than the width of the wiring harness 9 in the direction orthogonal to the wiring direction of the wiring harness 9.

In this configuration, the gap between the wiring harness 9 and the peripheral wall of the front housing 3 is filled with the rib 12, thus preventing a person from inserting fingers into the gap to grasp the wiring harness 9 and further lifting the compressor 1 by holding the wiring harness 9.

The configuration makes it possible to prevent the weight of the compressor 1 from being applied to the wiring harness 9 thereby to protect the wiring harness 9 from damage, such as disconnection. Thus, the durability of the wiring harness 9 can be satisfactorily maintained.

Further, the width of the top face of the rib 12 is equal to or greater than the width (diameter) of the wiring harness 9 thereby to prevent fingers from being caught by the bottom portion of the wiring harness 9. This arrangement makes it possible to further enhance the function to maintain the durability of the wiring harness 9.

Further, the rib 12 also has a reinforcing function, together with other reinforcing ribs formed on the boss 3b of the front housing 3. In other words, the configuration merely requires one of the reinforcing ribs to be replaced by the rib 12, thus requiring a minimum necessary design change and enabling an increase in weight to be suppressed.

FIG. 4 illustrates a second embodiment of the rib for securing the durability of the wiring harness.

In the second embodiment, a groove 21a into which at least the bottom portion of a wiring harness 9 is fitted is formed in the top portion of a rib 21. This configuration makes it possible to further enhance the effect for preventing fingers from entering between the wiring harness 9 and the rib 21.

FIG. 5 illustrates a third embodiment of the rib for securing the durability of the wiring harness.

In the third embodiment, a pair of ribs 31 is formed on both sides, sandwiching the wiring harness.

In this case also, the effect for preventing fingers from entering between a wiring harness 9 and the ribs 31 can be further enhanced.

The present invention can be applied to any types of compressor which has an electromagnetic clutch and in which a wiring harness for supplying electric power is fixed to a compressor housing, rather than being limited to the compressor used with a vehicle air conditioner.

### REFERENCE SYMBOL LIST

1 Compressor
2 Drive shaft
3 Front housing
3a Peripheral wall
3b Boss
4 Center housing
5 Rear housing
6 Electromagnetic clutch
6a Clutch housing
6b Connection opening
7 Pulley
9 Wiring harness
10 Fastening metal fitting
12 Rib
21 Rib
21a Groove
31 Rib

1. A compressor including a drive shaft which rotationally drives a compression mechanism and an electromagnetic clutch which is disposed on one end portion of the drive shaft to enable and disable the transmission of a driving force from a drive source to the drive shaft,
wherein a wiring harness which is electrically connected to the electromagnetic clutch and which is drawn out of a clutch housing is fixed to a predetermined portion of a peripheral wall of a compressor housing connected to the clutch housing, the predetermined portion of the peripheral wall being spaced away from the clutch housing, and
wherein the compressor housing is provided with a rib which prevents a finger from entering between the wiring harness and a wall surface of the compressor housing, the rib being formed along a wiring route of the wiring harness in a part between an outlet through which the wiring harness is drawn out from the clutch housing and the peripheral wall to which the wiring harness is fixed.

2. The compressor according to claim 1, wherein the rib is formed such that a top face thereof is close to the wiring harness.

3. The compressor according to claim 2, wherein the width of the top face of the rib is equal to or greater than the width of the wiring harness in a direction orthogonal to a wiring direction of the wiring harness.

4. The compressor according to claim 1, wherein a top part of the rib has a groove in which at least a part of the wiring harness is fitted.

5. The compressor according to claim 1, wherein a pair of the ribs is formed on both sides, sandwiching the wiring harness.

6. The compressor according to claim 1, wherein the wiring harness is electrically connected with an electromagnetic clutch through the connection with a connector at a connection opening disposed in a clutch housing wall.

7. The compressor according to claim 6, wherein the wiring harness is connected to the connector, being oriented toward the outer side in a radial direction of the clutch housing.

8. The compressor according to claim 1, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

9. The compressor according to claim 1, wherein the compressor is a compressor used with a vehicle air conditioner.

10. The compressor according to claim 2, wherein the wiring harness is electrically connected with an electromagnetic clutch through the connection with a connector at a connection opening disposed in a clutch housing wall.

11. The compressor according to claim 3, wherein the wiring harness is electrically connected with an electromagnetic clutch through the connection with a connector at a connection opening disposed in a clutch housing wall.

12. The compressor according to claim 4, wherein the wiring harness is electrically connected with an electromagnetic clutch through the connection with a connector at a connection opening disposed in a clutch housing wall.

13. The compressor according to claim 5, wherein the wiring harness is electrically connected with an electromagnetic clutch through the connection with a connector at a connection opening disposed in a clutch housing wall.

14. The compressor according to claim 2, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

15. The compressor according to claim 3, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

16. The compressor according to claim 4, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

17. The compressor according to claim 5, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

18. The compressor according to claim 6, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

19. The compressor according to claim 7, wherein a part of the compressor house extending from a surface thereof connected with the clutch housing to a peripheral wall to which the wiring harness is fixed is formed into a boss having a diameter that is smaller than the diameters of the clutch housing and the peripheral wall part of the compressor housing.

20. The compressor according to claim 8, wherein the compressor is a compressor used with a vehicle air conditioner.
